(19) United States
(12) Patent Application Publication
(10) Pub. No.: US 2019/0362283 A1
(43) Pub. Date: Nov. 28, 2019

(54) WORKING EQUIPMENT SPECIFICATION SUPPORT APPARATUS, WORKING EQUIPMENT SPECIFICATION SUPPORT METHOD, AND WORKING EQUIPMENT SPECIFICATION SUPPORT SYSTEM

(71) Applicant: Hitachi, Ltd., Tokyo (JP)

(72) Inventors: Motonobu SAITO, Tokyo (JP); Yuuichi SUGINISHI, Tokyo (JP); Satoshi FUKUDA, Tokyo (JP); Satoshi MINEWAKI, Tokyo (JP); Masahiro HORITA, Tokyo (JP)

(21) Appl. No.: 16/296,534

(22) Filed: Mar. 8, 2019

(30) Foreign Application Priority Data
May 23, 2018 (JP) 2018-098422

(51) Int. Cl. G06Q 10/06

(52) U.S. Cl. CPC G06Q 10/06312

(57) ABSTRACT

A working equipment specification support apparatus includes: a storage device that stores workable equipment candidate information which is information of a workable equipment candidate for each process, and workable item attribute condition information which is a workable item attribute condition for each equipment or each combination of equipment and a process; and an operation device that executes processing of specifying a workable equipment candidate related to a predetermined process from the workable equipment candidate information, processing of determining whether or not a predetermined item attribute satisfies regulations in the workable item attribute condition information for each specified equipment candidate or for each combination of the specified equipment candidate and the predetermined process, and processing of specifying an equipment candidate that whose item attribute is determined to satisfy the regulations in the determination as equipment that can perform working on an item corresponding to the item attribute in the process.

### CROSS-REFERENCE TO RELATED APPLICATIONS

The present application claims priority pursuant to 35 U.S.C. § 119 from Japanese Patent Application No. 2018-098422, filed on May 23, 2018, the entire disclosure of which is incorporated herein by reference.

### BACKGROUND

The present invention relates to a working equipment specification support apparatus, a working equipment specification support method, and a working equipment specification support system, and more specifically relates to a technology for efficiently generating and managing information of working equipment to be employed for each combination of an item and a process in a production plan.

When a production plan is made, information such as which equipment can be used, that is, which process can be carried out for working of an item for each combination of an item such as a product to be produced or a part thereof and a process such as cutting and forging of such parts, and further, which equipment should be preferentially used to perform working on an item, is required.

On the other hand, the aforementioned information has complicated aspects in new creation, data addition, update, and the like. For example, when new information is created, it is necessary to create data of a combination of an item and a process, which is extremely troublesome fora person in charge. Also, when a new item is added, it is necessary to add data for the number of a series of processes related to the item each time, and this operation also becomes complicated. Then, when adding equipment, it is necessary to update the data of the combination of the item and the process each time, and this operation also becomes complicated.

Therefore, in a related art focusing on such problems, for example, an operation schedule planning device for a production machine (refer to JP-A-H05-233909), which is an apparatus for planning an operation schedule of a production machine in order to sequentially process a plurality of items to be processed by operating a plurality of production machines, and includes a processing capability data storage device that stores processing capability data related to the intrinsic processing capability of each production machine, an item data storage device that stores item data showing individual processing contents related to the processing capability for each item to be processed, an operation processing device that makes up a schedule table in which each item in the item data is assigned to predetermined production machines and the items to be processed for each production machine are arranged in order to be processed by referring to the processing capability data, and an assignment data storage device that stores assignment data showing the past fact that a specific item was assigned to a specific production machine, in which in a case where the operation processing device newly assigns items that are the same as or similar to the items in the assignment data, the items are assigned preferentially to the same or similar production machines as in the past assignment indicated in the assignment data.

However, in the related art, an operation for preparing the processing capability data showing the intrinsic processing capability of each production machine by the number of production machines (or the number of variations) in advance, an update operation thereof, and the like are required.

Under these conditions, in a case where the number of production machines (or the number of variations) is correspondingly large, when the person in charge performs the above-mentioned respective operations on the basis of the manual operation, the respective operations become very complicated. This causes an increase in human and economic costs, and thus it is hard to say that this method is a practical solution. Further, in a case where it is necessary to consider equipment assigned for each process, the complication described above is further increased.

### SUMMARY

Accordingly, an objective of the present invention is to provide a technique for efficiently generating and managing information of a working equipment to be employed for each combination of an item and a process in a production plan.

According to an aspect of the present invention, there is provided a working equipment specification support apparatus including: a storage device that stores workable equipment candidate information which is information of a workable equipment candidate for each process, and workable item attribute condition information which is a workable item attribute condition for each equipment or each combination of an equipment and a process; and an operation device that executes processing of specifying a workable equipment candidate related to a predetermined process from the workable equipment candidate information, processing of determining whether or not a predetermined item attribute satisfies regulations in the workable item attribute condition information for each specified equipment candidate or for each combination of the specified equipment candidate and the predetermined process, and processing of specifying an equipment candidate that is determined that an item attribute satisfies the regulations in the determination as equipment that can perform working on an item corresponding to the item attribute in the process.

According to another aspect of the present invention, there is provided a working equipment specification support method including: executing, by an information processing system including a storage device that stores workable equipment candidate information which is information of a workable equipment candidate for each process, and workable item attribute condition information which is a workable item attribute condition for each equipment or each combination of equipment and a process, processing of specifying a workable equipment candidate related to a predetermined process from the workable equipment candidate information, processing of determining whether or not a predetermined item attribute satisfies regulations in the workable item attribute condition information for each specified equipment candidate or for each combination of the specified equipment candidate and the predetermined process, and processing of specifying an equipment candidate determined that an item attribute satisfies the regulations in the determination as equipment that can perform working on an item corresponding to the item attribute in the process.

According to still another aspect of the present invention, there is provided a working equipment specification support system including at least: a working equipment specification support apparatus having a storage device that stores workable equipment candidate information which is information of a workable equipment candidate for each process, and workable item attribute condition information which is a workable item attribute condition for each equipment or each combination of equipment and a process, and an operation device that executes processing of specifying a workable equipment candidate related to a predetermined process from the workable equipment candidate information, processing of determining whether or not a predetermined item attribute satisfies regulations in the workable item attribute condition information for each specified equipment candidate or for each combination of the specified equipment candidate and the predetermined process, and processing of specifying an equipment candidate determined that an item attribute satisfies the regulations in the determination as an equipment that can perform working on an item corresponding to the item attribute in the process; and one or more equipment that are specified as workable equipment by the working equipment specification support apparatus, generate production result information including combined information of items, processes, and equipment, and distributes the information to the working equipment specification support apparatus.

According to the present invention, it is possible to efficiently generate and manage information of working equipment to be employed for each combination of an item and a process in a production plan.

### BRIEF DESCRIPTION OF DRAWINGS

FIG. 1 is an overall configuration diagram of a working equipment specification support system according to an embodiment;

FIG. 2 is a configuration diagram of an item attribute management DB in the embodiment;

FIG. 3 is a configuration diagram of a process order management DB in the embodiment;

FIG. 4 is a configuration diagram of an equipment specification management DB in the embodiment;

FIG. 5 is a configuration diagram of a workable equipment candidate management DB in the embodiment;

FIG. 6 is a configuration diagram of a workable item attribute condition management DB in the embodiment;

FIG. 7 is a configuration diagram of a production result management DB in the embodiment;

FIG. 8 is a diagram showing data of a priority order determination rule in the embodiment;

FIG. 9 is a flowchart of workable process calculation processing in the embodiment;

FIG. 10 is a flowchart of workable item attribute calculation processing in the embodiment;

FIG. 11 is a flowchart of workable equipment specifying processing in the embodiment; and

FIG. 12 is a screen view of a workable equipment specifying screen in the embodiment.

### DETAILED DESCRIPTION OF THE EMBODIMENTS

### System Configuration Example

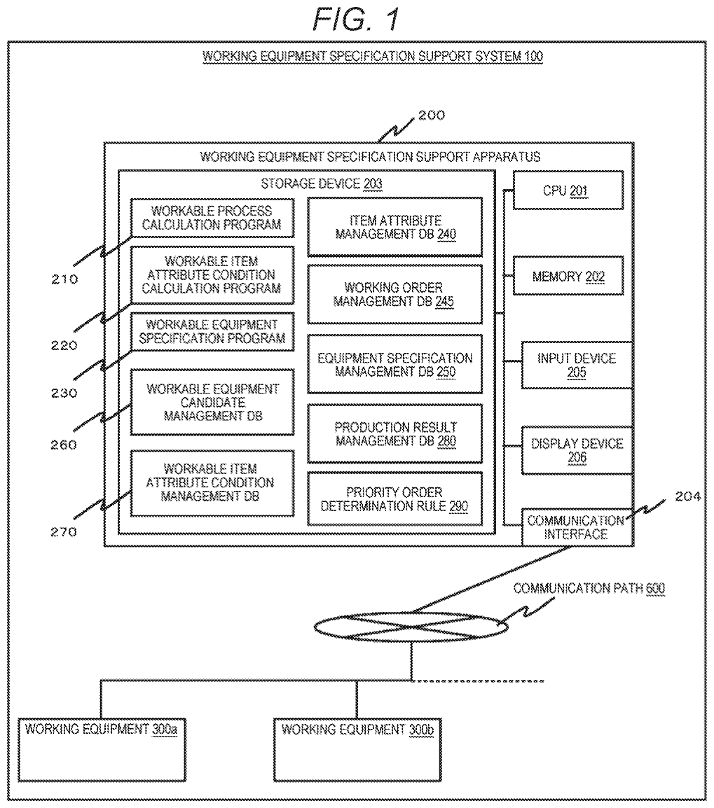

Hereinafter, preferable embodiments of the present invention will be described with reference to the drawings. FIG. 1 is an overall configuration diagram of a working equipment specification support system according to an embodiment.

A working equipment specification support system 100 according to the embodiment is configured to include a working equipment specification support apparatus 200, one or more working equipment 300 (300a, 300b,... ), and a communication path 600 connecting these devices. The communication path 600 is, for example, a standard communication path such as a wired LAN (Local Area Network) or a wireless LAN.

Among them, for example, assuming that the working equipment specification support device is a PC, the working equipment specification support apparatus 200 specifies the workable working equipment 300 (300a, 300b,... ) for each combination of an item and a process including the order of priority. The item to be worked is a product to be worked or a part thereof. In addition, the term “process” is a procedure that applies various kinds of working such as cutting, grinding, shearing, forging, rolling and the like to the item to be worked to attain the required specifications determined by the design.

On the other hand, the working equipment specification support apparatus 200 is configured to include a CPU 201 serving as an operation device, a memory 202 constituted of a volatile storage element, a storage device 203 constituted of a nonvolatile storage element, a communication interface 204 corresponding to a protocol of the communication path 600, an input device 205, and a display device 206.

The communication interface 204 is, for example, an interface such as a wired LAN card or a wireless LAN card and communicates with the working equipment 300 (300a, 300b,... ) via the communication path 600.

In addition, the input device 205 is a device such as an input button, a touch panel, a keyboard, a mouse, and the like, through which a device operator performs various types of input to the working equipment specification support apparatus 200.

Further, the display device 206, such as a liquid crystal display or the like, is a device for displaying a processing result to a device user on the working equipment specification support apparatus 200.

As for the input device 205 and the display device 206, a configuration in which another device (not shown) is connected to the working equipment specification support apparatus 200 via the communication path 600 and an input device and a display device of the other device are used may be adopted.

Further, the storage device 203 is a storage means including a nonvolatile storage element for storing a program and data, such as a hard disk or a flash memory. The storage device 203 includes, as stored programs, at least a workable process calculation program 210, a workable item attribute condition calculation program 220, and a workable equipment specification program 230.

In addition to the programs described above, the storage device 203 stores, as data, at least an item attribute management DB 240, a process order management DB 245, an equipment specification management DB 250, a workable equipment candidate management DB 260, a workable item attribute condition management DB 270, a production result management DB280, and a priority order determination rule 290.

Among the programs stored in the storage device 203 described above, the workable process calculation program. 210 is a program for executing workable process calculation processing of calculating the priority order of candidates of the workable working equipment 300 (300a, 300b,... ) for each process based on the production results stored in the production result management DB 280, and registering the calculated result in the workable equipment candidate management DB 260. The details of the workable process calculation processing are shown in the description of FIG. 9 which will be described later.

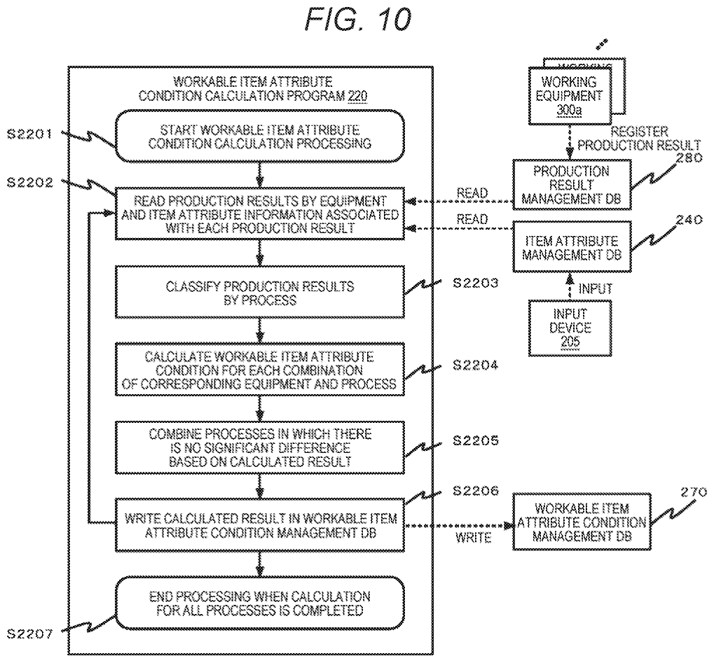

In addition, the workable item attribute condition calculation program 220 is a program for executing the workable item attribute condition calculation processing of calculating workable item attribute conditions (for example, minimum length, maximum length, material, and the like) for each working equipment 300 (300a, 300b,... ) or for each combination of working equipment 300 and a process based on the production results stored in the production result management DB 280, and registering the calculated results in the workable item attribute condition management DB 270. The details of the workable item attribute condition calculation processing are shown in the description of FIG. 10 which will be described later.

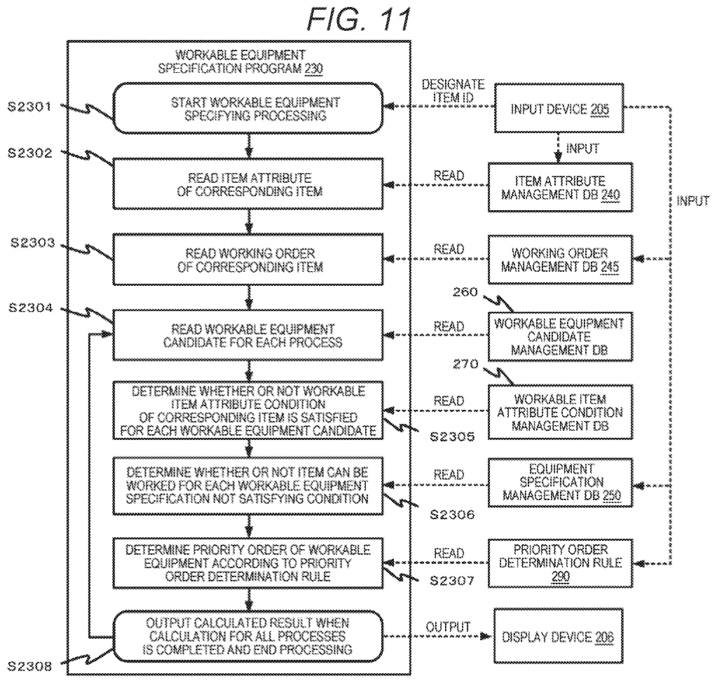

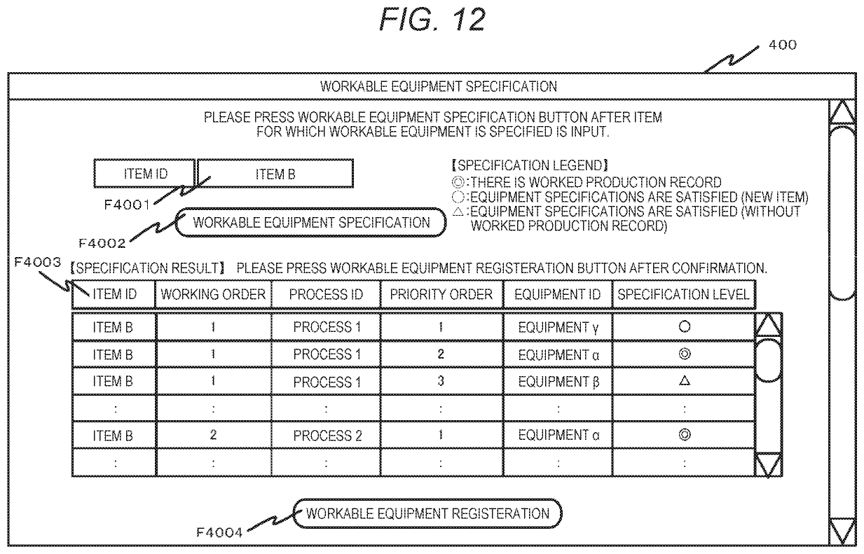

Further, the workable equipment specification program 230 is a program for executing workable equipment specifying processing of specifying the working equipment 300 (300a, 300b,... ) for each process required for working the item designated by a user including the priority order, and outputting the result to the display device 206 as a workable equipment specification screen. The details of the workable equipment specifying processing are shown in the description of FIG. 11 which will be described later. In addition, the details of the workable equipment specification screen are shown in the description of FIG. 12 which will be described later.

Each of the above-mentioned programs stored in the storage device 203 is read into the memory 202 and executed by the CPU 201, whereby each processing is executed.

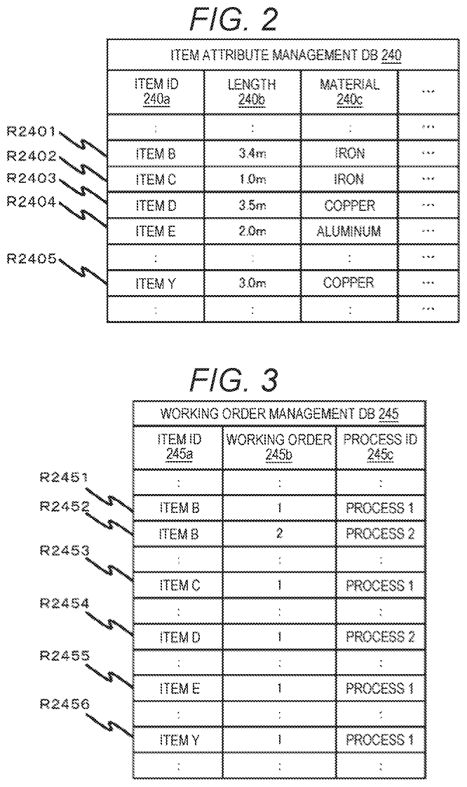

Among the data held by the storage device 203, the item attribute management DB 240 is a database for managing the attributes of the items to be worked. The configuration of the item attribute management DB 240 is shown in the description of FIG. 2 which will be described later.

Each record of the item attribute management DB 240 is set by the user by the input device 205 or the like while being displayed on the display device 206, and is also set based on data transmission and reception with another apparatus connected to the working equipment specification support apparatus 200 via the communication path 600.

In addition, the process order management DB 245 is a database for managing the processes and order of processes (=process order) for each item to be worked. The configuration of the process order management DB 245 is shown in the description of FIG. 3 which will be described later.

Each record of the process order management DB 245 is set by the user by the input device 205 or the like while being displayed on the display device 206, and is also set based on data transmission and reception with another apparatus connected to the working equipment specification support apparatus 200 via the communication path 600.

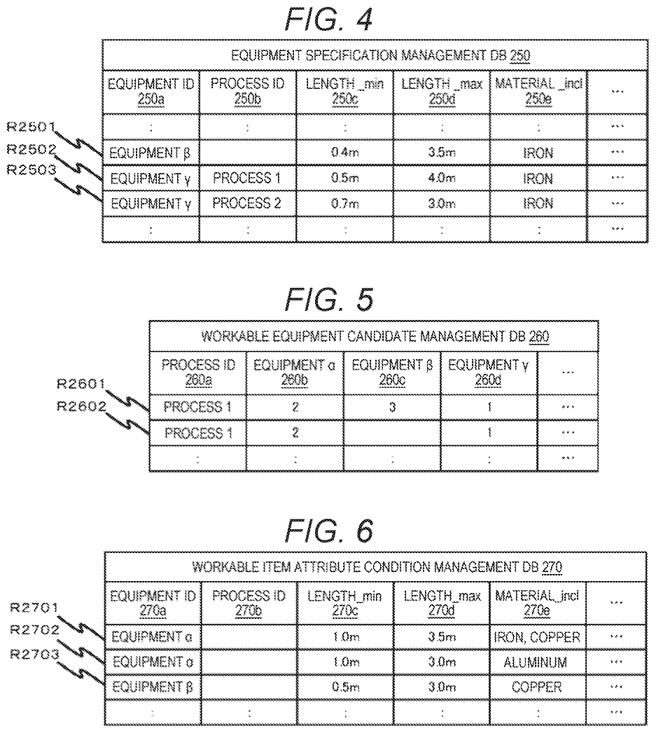

In addition, the equipment specification management DB 250 is a database for managing the specifications of the working equipment 300 (300a, 300b,... ). The configuration of the equipment specification management DB 250 is shown in the description of FIG. 4 which will be described later.

Each record of the equipment specification management DB 250 is set by the user by the input device 205 or the like while being displayed on the display device 206, and is also set based on data transmission and reception with another apparatus connected to the working equipment specification support apparatus 200 via the communication path 600.

In addition, the workable equipment candidate management DB 260 is a database for managing the candidates of the workable working equipment 300 (300a, 300b,... ) for each process including the priority order. The configuration of this workable equipment candidate management DB 260 is shown in the description of FIG. 5 which will be described later.

Each record of the workable equipment candidate management DB 260 is set by the workable process calculation program 210, and is also set by the input device 205 or the like while being displayed on the display device 206.

Further, the workable item attribute condition management DB 270 is a database for managing workable item attribute conditions (for example, minimum length, maximum length, material, and the like) for each working equipment 300 (300a, 300b,... ) or for each combination of working equipment 300 and a process. The configuration of this workable item attribute condition management DB 270 is shown in the description of FIG. 6 which will be described later.

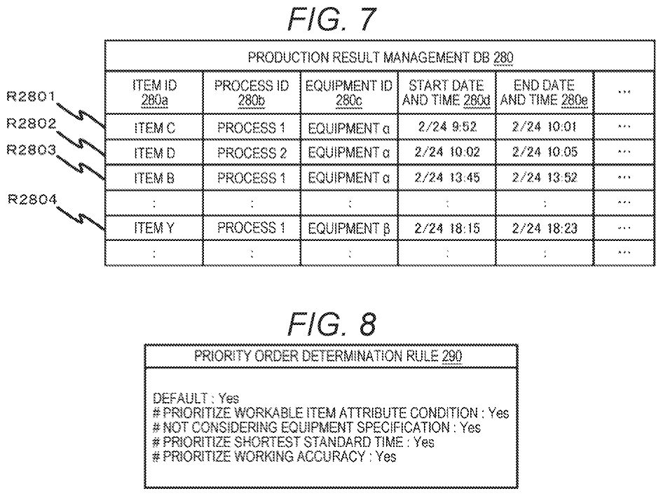

In addition, the production result management DB 280 is a database for managing production results by the working equipment 300 (300a, 300b,... ). The configuration of the production result management DB 280 is shown in the description of FIG. 7 which will be described later.

Each record of the production result management DB 280 is set based on the production results transmitted from the working equipment 300 (300a, 300b,... ) via the communication path 600. The configuration of the transmitted or received production result is the same as the configuration of the production result management DB 280.

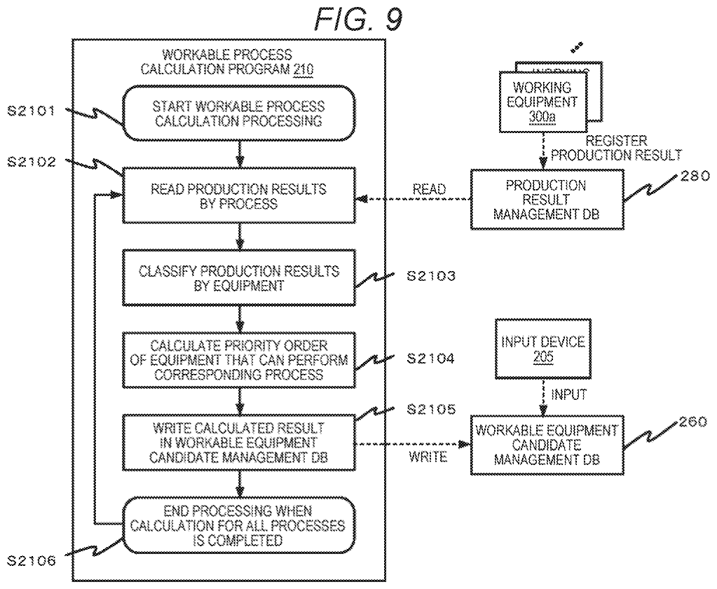

Further, the priority order determination rule 290 is data used finally for determining the priority order of equipment that can be worked in the workable equipment specifying processing (FIG. 11) which will be described later. The configuration of the priority order determination rule 290 is shown in the description of FIG. 8 which will be described later.

The priority order determination rule 290 is set, while being displayed on the display device 206, by the user by the input device 205 or the like, and is also set based on data transmission and reception with another apparatus connected to the working equipment specification support apparatus 200 via the communication path 600.

The working equipment 300 (300a, 300b,... ) connected to the communication path 600 is, for example, a machine tool, performs working that can be performed for each machine tool on an object to be worked, generates the contents and result thereof as production results, and distributes the results to the working equipment specification support apparatus 200 via the communication path 600 in real time or batch. As described above, the configuration of the production results distributed here is the same as the configuration of the production result management DB 280.

### Example of Specific Data Configuration

Next, a specific configuration of each data held in the storage device 203 will be described. FIG. 2 is a configuration diagram of the item attribute management DB 240 in the embodiment.

The item attribute management DB 240 includes at least an item ID 240a as a record field and includes, for example, a length 240b and a material 240c as attributes of an item to be worked.

The attributes of the item to be worked are not limited to the length 240b and the material 240c, and width, thickness, required quality level, and the like can be assumed. However, a configuration in a case where only the length 240b and the material 240c are taken as attributes of the item to be worked is shown here.

Next, FIG. 3 is a configuration diagram of the process order management DB 245 in the embodiment. The process order management DB 245 includes at least an item ID 245a, a process order 245b, and a process ID 245c as fields of a record.

In each record, it can be grasped that a process in which the item shown in the item ID 245a can be worked in the working order shown in the process order 245b is a process shown in the process ID 245c.

Next, FIG. 4 is a configuration diagram of the equipment specification management DB 250 in the embodiment. The equipment specification management DB 250 includes at least an equipment ID 250a which is an ID of the working equipment 300 (300a, 300b, . . . ) as a field of the record, and as attribute conditions of a workable item on the specifications of the working equipment 300, for example, a length_min 250c, a length_max 250d, and a material incl 250e.

The attribute conditions of the workable item on the specifications of the working equipment 300 are not limited to the length_min 250c, the length_max 250d, and the material incl 250e described above, and a width min (a minimum value of workable width on the equipment specifications), a width max (a maximum value of workable width on the equipment specifications), a thickness min (a minimum value of workable thickness on the equipment specifications), a thickness max (a workable maximum thickness on the equipment specifications), a quality level (a workable quality level on the equipment specifications), and the like can be assumed. However, a configuration in a case where only the length_min 250c, the length_max 250d, and the material incl 250e are taken as the attribute conditions of the workable item on the specifications of the working equipment 300 is shown here.

As for the length_min 250c, the minimum value, shown in the equipment ID 250a of the record, of the length that can be worked by the working equipment 300 on the equipment specifications is set. Also, for the length_max 250d, the maximum value, shown in the equipment ID 250a of the record, of the length that can be worked by the working equipment 300 on the equipment specifications is set.

Further, in the material incl 250e, on the specifications of the working equipment 300, in a case where the attribute conditions of a workable item vary depending on difference in material of an item to be worked, one or more material names having, as attribute conditions of a workable item, the length_min 250c and the length_max 250d of the record are registered.

On the specifications of the working equipment 300, in a case where the attribute conditions (a combination of the length_min 250c, the length_max 250d, and the material incl 250e ) of a workable item vary depending on difference in a process to be worked, the process ID 250b is added as the field of the record of the equipment specification management DB 250.

In the process ID 250b, the process corresponding to the attribute conditions (a combination of the length_min 250c, the length_max 250d, and the material incl 250e ) of the workable item shown in the record is registered.

Next, FIG. 5 is a configuration diagram of the workable equipment candidate management DB 260 in the embodiment. The workable equipment candidate management DB 260 includes at least a process ID 260a and additionally includes fields (an equipment α 260b, an equipment β 260c, an equipment γ 260d, ...) corresponding to each of one or more working equipment 300 (300a, 300b, . . . ) as fields of records.

In each record, candidate information can be grasped indicating which working equipment 300 (the equipment α 260b, the equipment β 260c, the equipment γ 260d, . . . ) can be used to work the process shown in the process ID 260a and further, which working equipment 300 should be preferentially used to perform working on an item.

For example, in a record R2602, it can be grasped that candidates of the working equipment 300 that can execute the process of “Process 2” are “Equipment α” and “Equipment γ”, working cannot be performed in “Equipment β”, the equipment to be employed most preferentially is “Equipment γ” in which “1” is registered, and the equipment to be employed next is “Equipment α” in which “2” is registered.

FIG. 6 is a configuration diagram of the workable item attribute condition management DB 270 in the embodiment. The workable item attribute condition management DB 270 includes at least an equipment ID 270a which is the ID of the working equipment 300 (300a, 300b, . . . ) as a field of a record, and also includes, as attribute conditions of a workable item on the production result of the working equipment 300, a length_min 270c, a length_max 270d, and a material incl 270e.

On the production results of the working equipment 300, the attribute conditions of the workable item are not limited to the length_min 270c, the length_max 270d, and the material incl 270e described above, and a width min (a minimum value of workable width on the production results), a width max (a maximum value of workable width on the production results), a thickness min (a minimum value of workable thickness on the production results), a thickness max (a workable maximum thickness on the production results), a quality level (a workable quality level on the production results), and the like can be assumed. However, a configuration in a case where only the length_min 270c, the length_max 270d, and the material incl 270e are taken as the attribute conditions of the workable item on the production results of the working equipment 300 is shown here.

As for the length_min 270c, the minimum value of the length that can be worked on the production results by the working equipment 300 shown in the equipment ID 270a of the record is set. Also, for the length_max 270d, the maximum value of the length that can be worked on the production results by the working equipment 300 shown in the equipment ID 270a of the record is set.

Further, in the material incl 270e, on the production results of the working equipment 300, in a case where the attribute conditions of a workable item vary depending on difference in material of an item to be worked, one or more material names having, as attribute conditions of a workable item, the length_min 270c and the length_max 270d of the record are registered.

On the production results of the working equipment 300, in a case where the attribute conditions (a combination of the length_min 270c, the length_max 270d, and the material incl 270e ) of a workable item vary depending on difference in process to be worked, the process ID 270b is added as the field of the record of the workable item attribute condition management DB 270.

In the process ID 270b, the process corresponding to the attribute conditions (a combination of the length_min 270c, the length_max 270d, and the material incl 270e) of the workable item shown in the record is registered.

Although the configuration of the workable item attribute condition management DB 270 described in FIG. 6 and the configuration of the equipment specification management DB 250 described in FIG. 4 completely coincide, different workable item attribute fields may be provided and managed respectively.

Next, FIG. 7 is a configuration diagram of the production result management DB 280 in the embodiment. The production result management DB 280 includes at least an item ID 280a, a process ID 280b, and an equipment ID 280c as fields of a record.

In the example of FIG. 7, the fields of a start date and time 280d and an end date and time 280e of each production result included in general production results in many cases are also provided, but the fields of a start date and time and an end date and time of each production result can be omitted if not particularly used. In addition, even when the fields of the start date and time 280d and the end date and time 280e are provided, and even when the fields of the start date and time and the end date and time are blank, there is no particular problem in this embodiment.

In each record of the production result management DB 280, it can be grasped that there is a record that a combination of the item shown in the item ID 280a and the process shown in the process ID 280b has been produced by the working equipment 300 (300a, 300b, . . . ) shown in the equipment ID 280c. Further, in each record, it can be grasped that the production started at the date and time shown in the start date and time 280d and ended at the date and time shown in the end date and time 280e.

Next, FIG. 8 is a diagram showing the details of data of the priority order determination rule 290 in the embodiment. As described above, the priority order determination rule 290 is data used finally for determining the priority order of the workable working equipment 300 (300a, 300b, . . . ) that is in the workable equipment specifying processing (which will be described later, FIG. 11), and is prepared in the form of a text-based setting file or the like.

As for the priority order determination rule 290, in each line, it is described in the format of “priority order determination rule name: Yes/No”, and if a “#” is at the beginning of the line, the line is regarded as a comment line and ignored. That is, the priority order determination rule described as “priority order determination rule name: Yes” without “#” at the beginning is taken into consideration. The behavior based on each priority order determination rule is shown in the description of Step S2307 in FIG. 11 which will be described later.

### Example 1 of Flowchart

Hereinafter, an actual procedure of a working equipment specification support method in the embodiment will be described with reference to the drawings. Various operations corresponding to the working equipment specification support method described below are realized by a program that is read by the devices and the like configuring the working equipment specification support system 100 into the memory thereof or the like and executed. The program is constituted of codes for performing various operations to be described below.

FIG. 9 is a diagram showing an example of a flow of workable process calculation processing in the working equipment specification support method in the embodiment. The CPU 201 executes the workable process calculation program 210, calculates the candidates of workable working equipment 300 (300a, 300b, . . . ) for each process based on the production results stored in the production result management DB 280 including their priority order, and registers the result to the workable equipment candidate management DB 260.

In this case, first, the workable process calculation program 210 starts the workable process calculation processing by receiving a request of a user from the input device 205 or by receiving a periodic automatic schedule execution request (S2101). In Step S2101, when the above-described request is received from the input device 205, the request is given from the input device 205 while displaying the processing contents on the display device 206.

Next, the CPU 201 reads all the production results for each process from the production result management DB 280 (S2102). For example, when the processing starts from the process of “Process 1” here, a record of the process ID 280b=“Process 1” in the production result management DB 280 shown in FIG. 7, that is, records R2801, R2803, and R2804 are read.

Next, the CPU 201 classifies the production results read in Step S2102 described above by the working equipment 300 (S2103). For example, when the records R2801, R2803, and R2804 are read as production results in the process of “Process 1” in Step S2102, the records are classified into records R2801 and R2803 of the equipment ID 280c =“Equipment α” and a record R2804 of the equipment ID 280c=“Equipment β”.

Next, based on the production results (=the records of the production result management DB 280) classified in Step S2103 described above by the working equipment, the CPU 201 calculates the priority order of the working equipment that can execute the process (=the process in which processing has started in Step S2102) (S2104).

As a method of calculating the priority order, there is a method of setting the priority order in the order starting from the working equipment 300 including the latest date and time in the start date and time 280d and the end date and time 280e, in addition to a method of setting the priority order in the order of working equipment having a high production result.

For example, in consideration of a case where the method of setting the priority order in the order of working equipment having a high production result is employed as the method of calculating the priority order, when, as the production results of the process of “Process 1”, two production records (records R2801 and R2803) related to the working equipment of “Equipment α” are acquired, and one production result (R2804) related to the working equipment of “Equipment β” is acquired up to Step S2103, the priority order of “Equipment α” is “1”, and the priority order of “Equipment β” is “2” in the order of working equipment with a high production result.

Next, the CPU 201 writes, into the workable equipment candidate management DB 260 (S2105), the calculated result in Step S2104 described above, that is, the priority order of the working equipment that can execute the process (=the process in which processing has started in Step S2102).

In the example of a series of processing processes started from the process of “Process 1” in Step S2102, the record in which the process ID 260a is “Process 1”, the equipment α 260b has a priority order “1”, and the equipment β has a priority order “2” is written in the workable equipment candidate management DB 260.

The reason why the value of the record of “Process 1” in the process ID 260a written in the workable equipment candidate management DB 260 is different from the value shown in FIG. 5 is that the value is corrected by a manual operation through the input device 205 or the like after the working equipment of “Equipment γ” is added to the working equipment specification support system 100.

Here, when the workable process calculation processing for all the processes is not completed, the process proceeds to Step S2102 to start the workable process calculation processing for the next process, and when the workable process calculation processing is completed, the processing is ended (S2106).

### Example 2 of Flowchart

Next, FIG. 10 shows an example of a flow of workable item attribute calculation processing in the working equipment specification support method in the embodiment. The CPU 201 calculates attribute conditions (for example, minimum length, maximum length, material, and the like) of items that can be worked for each working equipment 300 (300a, 300b, . . . ) or for each combination of working equipment 300 and a process by the workable item attribute calculation program 220 based on the production results stored in the production result management DB 280 and the item attribute information stored in the item attribute management DB 240, and registers the calculated result in the workable item attribute condition management DB 270.

In this case, first, the workable item attribute condition program 220 starts workable item attribute calculation processing by receiving a request of a user from the input device 205 or by receiving a periodic automatic schedule execution request (S2201). In Step S2201, when the above-described request is received from the input device 205, the request is given from the input device 205 while displaying the processing contents on the display device 206.

Next, the CPU 201 reads all the production results of each working equipment from the production result management DB 280. Then, the item attribute information of items associated with each production result read here is read from the item attribute management DB 240 (S2202).

For example, when processing is started from the working equipment of “Equipment α” here, the production results of a record of the equipment ID 280c=“Equipment α” in the production result management DB 280 shown in FIG. 7, that is, records R2801, R2802, and R2803, are read. Then, records of “Item C” “Item D”, and “Item B”, which are item IDs 280a of records R2801, R2802, and R2803 =items ID 240a of the item attribute management DB 240 shown in FIG. 2, that is, records R2402, R2403, and R2401, are read as item attribute information of items associated with each production result of the records R2801, R2802, and R2803.

Next, the CPU 201 classifies the production results read in Step S2202 described above by the process (S2203). For example, when the records R2801, R2802, and R2803 are read as production results in the working equipment 300 of “Equipment α” in Step S2202, the records are classified into records R2801 and R2803 of the process ID 280b=“Process 1” and a record R2802 of the process ID 280b=“Process 2”.

Next, based on the production results (=the records of the production result management DB 280) classified in Step S2203 described above by the process, the CPU 201 calculates workable item attribute conditions for each combination of the working equipment (=the working equipment that has started processing in Step S2202) and the process (S2204).

Specifically, with respect to the item attribute information (=the records of the item attribute management DB 240) of all the items associated with the production results, among the production result groups classified by process in Step S2203, the minimum value of length (=length_min) and the maximum value of length (=length_max) shown in the length 240b are calculated for each material shown in the material 240c.

For example, the records R2801, R2802, and R2803 of the production result management DB 280 (FIG. 7) are read as production results in the working equipment 300 of “Equipment α” in Step S2202, and the records R2402, R2403, and R2401 of the item attribute management DB 240 (FIG. 2) are read as the item attribute information of the items associated with each production result.

In this case, for example, as the workable item attribute condition of the item with the material 240c=“iron”, a value of “1.0 m” of the length 240b of the record R2402 is specified and calculated as the minimum value of the length, and a value of “3.4 m” of the length 240b of the record R2401 is specified and calculated as the minimum value of the length.

For materials that do not have a significant difference in the calculated results (a combination of the length_min and the length_max) (=for example, only a difference of 10%), as a combination of the calculated results, the minimum value of the length_min of each material and the maximum value of the length_max of each material are calculated as new calculated results of the materials.

For processes that do not have a significant difference in each calculated result calculated in Step S2204 (a combination of the length_min and the length_max) (=for example, only a difference of 10%), as a combination of the calculated results, the CPU 201 calculates the minimum value of the length_min of each process and the maximum value of the length_max of each process as new calculated results of those of processes (S2205).

Next, the CPU 201 writes the results calculated in the Steps S2204 and 2205 described above, that is, the attribute conditions of the item that can be worked by the working equipment (=the working equipment that has started processing in Step S2202) in the workable item attribute condition management DB 270 (S2206).

In the example of a series of processing processes started from the working equipment of “Equipment α” in Step S2202 described above, the record R2701 in which the equipment ID 270a is “Equipment α”, the process ID 270b is blank, the length_min 270c is “1.0 m”, the length_max 270d is “3.5 m”, and the material incl 270e=“iron, copper” is written in the workable item attribute condition management DB 270.

The reason why a plurality of materials are written in the material incl 270e is that the calculated results of the materials which do not have a significant difference are combined in Step S2204, and the reason why the process ID 270b is blank is that the calculated results of the processes that do not have a significant difference are combined in Step S2205.

The length_max=“3.4 m” calculated in Step S2204 differs from the length_max=“3.5 m” of the record DB 2701 of the workable item attribute condition management DB 270 due to these reasons.

Here, when the workable item attribute condition calculation processing for all the working equipment is not completed, the process proceeds to Step S2202 to start the workable item attribute condition calculation processing for the next working equipment, and when the workable process calculation processing is completed, the processing is ended (S2207).

### Example 3 of Flowchart

Next, FIG. 11 shows an example of a flow of workable equipment specifying processing in the working equipment specification support method in the embodiment. The CPU 201 specifies, by the workable equipment specification program 230, the working equipment 300 (300a, 300b, . . . ) that can be worked for each process required for each working of a specified item, including their priority order, and outputs the result to the display device 206 as a workable equipment specification screen.

In this case, first, the workable equipment specification program 230 starts workable equipment specifying processing (S2301) by receiving a predetermined user request including specification of an item ID from the input device 205.

The item ID specification is executed via the workable equipment specification screen displayed on the display device 206. The details of the workable equipment specification screen are shown in the description of FIG. 12 which will be described later. In addition, for item ID specification, there are various patterns such as a specification method by CUI, a specification method by automatic execution of a periodic schedule by a batch file, in addition to a specification method by GUI using the above-described workable equipment specification screen.

Next, the CPU 201 reads the item attribute information corresponding to the item ID specified in Step S2301 described above from the item attribute management DB 240 (S2302).

For example, when “item B” is specified as the item ID in Step S2301, the record of the item ID 240a=“item B” in the item attribute management DB 240 shown in FIG. 2, that is, the item attribute information of the record R2401, is read.

Next, the CPU 201 reads all the process order information corresponding to the item ID specified in Step S2301 described above from the process order management DB 245 (S2303).

For example, when “item B” is specified as the item ID in Step S2301, the record of the item ID 245a=“item B” in the process order management DB 245 shown in FIG. 3, that is, the process order information of records R2451 and R2452, is read.

Next, the CPU 201 reads all the workable equipment candidate information corresponding to each process ID included in the process order information read in Step S2303 from the workable equipment candidate management DB 260 (S2304).

For example, when “item B” is specified as the item ID in Step S2301 and the records R2451 and R2452 are read from the process order management DB 245 shown in FIG. 3 as process information in Step S2303, first, as the workable equipment candidate information corresponding to the process ID 245c=“Process 1” of the record R2451, the record of the process ID 260a=“Process 1”, that is, a record R2601, is read from the workable equipment candidate management DB 260. From the record R2601, it is grasped that the workable working equipment candidates are the equipment γ (priority order: 1), the equipment α (priority order: 2), and the equipment β (priority order: 3).

Next, the CPU 201 determines whether or not the item (=the item of the item ID specified in Step S2301) can be worked for each workable equipment candidate read in Step S2304 described above while referring to the workable item attribute condition management DB 270 (S2305).

For example, when “item B” is specified as the item ID in Step S2301, the record R2401 is read from the item attribute management DB 240 shown in FIG. 2 as the corresponding item attribute information in Step S2302, and the equipment γ (priority order: 1), the equipment α (priority order: 2), and the equipment β (priority order: 3) are grasped as workable equipment candidates in the process of “process 1” in Step S2304, it is confirmed whether or not the record satisfying the item attribute information (record R2401) exists in the workable item attribute condition management DB 270 for each of the equipment γ, the equipment α, and the equipment β.

Here, the record of the workable item attribute condition management DB 270 satisfying the conditions is a record in which the equipment ID 270a represents each workable equipment candidate (equipment γ, equipment α, and equipment β, the process ID 270b is the process ID (process 1) of the process or blank (=which means an arbitrary process), the material 240c of the item attribute information (record R2401) is included in the material incl 270e, and similarly, the length 240b of the item attribute is within a range of the length_mim 270c and the length_max 270d.

According to the specific confirmation method, it can be confirmed that for the equipment γ (priority order: 1), there is no record in which the equipment ID 270a is “Equipment γ”, for the equipment α (priority order: 2), the conditions are satisfied by the record R2701, and for the equipment β (priority order: 3), the conditions are not satisfied by the record R2703. As described above, three types of confirmation methods are performed.

Next, for each workable equipment candidate that does not satisfy the conditions in Step S2305 described above, the CPU 201 determines whether or not the item (=the item of the item ID specified in Step S2301) can be worked on the equipment specification, while referring to the equipment specification management DB 250 (S2306). For example, when “item B” is specified as the item ID in Step S2301, the record R2401 is read from the item attribute management DB 240 shown in FIG. 2 as the corresponding item attribute information in Step S2302, and the equipment γ (priority order: 1) and the equipment β (priority order: 3) are grasped as those which do not satisfy the conditions among the workable equipment candidates in the process of “Process 1” in Step S2305, it is confirmed whether or not there is a record satisfying the item attribute information (record R2401) in the equipment specification management DB 250 for each of the equipment γ and the equipment β.

Here, the record of the equipment specification management DB 250 satisfying the conditions is a record in which the equipment ID 250a represents each workable equipment candidate (equipment γ and equipment β, the process ID 250b is the process ID (process 1) of the process or blank (=which means an arbitrary process), the material 240c of the item attribute information (record R2401) is included in the material incl 250e, and similarly, the length 240b of the item attribute is within a range of the length mim 250c and the length_max 250d.

According to the specific confirmation method, it can be confirmed that for the equipment y, the conditions are satisfied by the record R2502, and for the equipment a, the conditions are also satisfied by the record R2501.

Next, the CPU 201 combines the workable equipment determined to satisfy the conditions in Step S2305 described above and the workable equipment determined to satisfy the conditions in Step S2306 described above, and determines the priority order of the workable equipment according to the priority order determining rule shown in the priority order determination rule 290 (FIG. 8) (S2307).

When the priority order determination rule is “Default”, the priority order is finally determined by reordering the priority order in descending priority order of 1, 2, . . . based on the priority order shown in the workable equipment candidate management DB 260, excluding the workable equipment candidate not satisfying the conditions.

For example, in the example of a series of processing processes in which “item B” is specified as the item ID in Step S2301, and processing is started for the process of “Process 1” in Step S2304, when the priority order determination rule is “Default” here, the priority order of the equipment γ (priority order: 1), the equipment α (priority order: 2), and the equipment β (priority order: 3) is finally determined.

When the priority order determination rule is “prioritize workable item attribute conditions”, the priority order is reordered such that the workable equipment determined to satisfy the conditions in Step S2305 has a high priority order and the workable equipment determined to satisfy the conditions in Step S2306 has a low priority order.

In addition, when the priority order determination rule is “not consider equipment specifications”, the workable equipment determined to satisfy the conditions in Step S2306 is excluded from the priority order.

In addition, there may be various priority determination rules such as “prioritize shortest standard time” or “prioritize working accuracy” for the priority order determination rule. Also, there are various variations such as a combination of priority determination rules, weighting between combinations, and the like.

Here, when the workable equipment specifying processing for each process from. Step S2304 is not completed, the process proceeds to Step S2304 to start the workable equipment specifying processing for the next process, and when the workable equipment specifying processing is completed, all results are outputted to the display device 206 as a workable equipment specification screen 400 and the processing is ended (S2308).

### Examples of Screen

Next, FIG. 12 shows a configuration example of the workable equipment specification screen 400. In the workable equipment specification screen 400, a device user of the working equipment specification support apparatus 200 operates the input device 205 while watching the display device 206.

The workable equipment specification screen 400 has an input field F4001 in which the item ID of the item for which a workable equipment is to be specified is inputted. Ina state in which the item ID is inputted in the input field F4001, by pressing a workable equipment specification button F4002, the working equipment specification support apparatus 200 displays the workable equipment including the priority order and the specification level for each process order and each process (each process ID) required for working the item ID in a table F4003.

Here, in a state in which the item ID is inputted in the input field F4001, the pressing of the workable equipment specification button F4002 corresponds to Step S2301 shown in FIG. 11. In addition, similarly, the displaying of the result in the table F4003 corresponds to Step S2308 shown in FIG. 11.

The table F4003 corresponds to the contents output in Step S2308 as described above, and each line shows that the equipment that can perform working on the item of “Item ID” in the process shown in “Process order” and “Process ID” is equipment shown in “Equipment ID”, and the priority order is the order shown in the “priority order”.

In addition, as for “specification level”, when it is determined that the conditions are satisfied in Step S2305 in the flow of the workable process calculation specifying processing in FIG. 11, “@”, indicating that “there is a worked production result”, is set.

In addition, there is no record related to the equipment in Step S2305, but when it is determined that the conditions are satisfied in Step S2306, “o”, indicating a “new item satisfying the equipment specifications”, is set.

Also, there is a record that does not satisfy the conditions in Step S2305, but when it is determined that the conditions are satisfied in Step S2306, “Δ”, indicating that “equipment specifications are satisfied but there is no production result worked under the conditions” is set.

Further, in each line of the table F4003, a detail confirmation button or the like may be provided so that the detailed contents of the specification result of each line can be confirmed. For example, as the detailed contents thereof, information of a corresponding record in the equipment specification management DB 250, information of a corresponding record in the production result management DB 280, and the like can be assumed.

In addition, a delete button or the like may be provided in each line of the table F4003 so that each line can be deleted.

Further, the data of the table F4003 may be displayed on the workable equipment specification screen 400 or may be stored in the storage device 203.

It is preferable that the data of the table F4003 is registered in a predetermined production scheduler or the like by pressing a workable equipment registration button F4004 in a state in which the data is displayed in the table F4003. In addition, there may be a configuration that the data is stored in the storage device 203.

It should be noted that the present invention is not limited to the above-described embodiments, and includes various modified examples. For example, the above-described embodiments have been described in detail in order to explain the present invention in an easy-to-understand manner, and are not necessarily limited to those having all the described configurations.

In addition, it is possible to replace a part of the configuration of one embodiment with another configuration. Further, it is possible to add, delete, and replace another configuration with respect to a part of the configuration of the embodiment. Further, each of the above-described configurations, functions, processing units, processing means, and the like may be realized by hardware, for example, by designing a part or the whole thereof with an integrated circuit or the like. Information on programs, tables, files, and the like that realize each function can be stored in a recording device such as a memory, a hard disk, a solid state drive (SSD), or a recording medium such as an IC card, an SD card, or a DVD.

According to this embodiment, it is possible to efficiently generate and manage the information of the working equipment to be employed for each combination of the item and the process in the production plan.

From the description of the specification, at least the following will be clarified. That is, in the working equipment specification support apparatus of the embodiment, the storage device may store information including the priority order of a workable equipment candidate for each process as the workable equipment candidate information, and the operation device may specify a workable equipment candidate from the workable equipment candidate information based on the priority order in the processing of specifying the workable equipment candidate related to the predetermined process, and may specify the determined equipment candidate as an equipment that can perform working on the item corresponding to the item attribute in the process based on the priority order in the processing of specifying the determined equipment candidate as an equipment that can perform working on the item corresponding to the item attribute in the process.

According to this embodiment, it is possible to specify the priority order among the equipment candidates to be used for working, present the priority order to a user or the like, and to make the selection of the employed equipment more efficient. As a result, it is possible to more efficiently generate and manage the information of the working equipment to be employed for each combination of the item and the process in the production plan.

In the working equipment specification support apparatus of the embodiment, the storage device may further store one or more pieces of production result information including combined information of items, processes, and equipment, and item attribute information for each item, and the operation device may further execute processing of acquiring item attribute information corresponding to each item showing the production result information from the storage device, processing of calculating the workable equipment candidate information based on the worked production result for each process shown by the production result information and storing the workable equipment candidate information in the storage device, and processing of calculating the workable item attribute condition information based on the production result information and the item attribute information and storing the workable item attribute condition information in the storage device.

According to the embodiment, it is possible to specify the equipment candidate to be used for working with high accuracy based on the production result thereof. As a result, it is possible to more efficiently generate and manage the information of the working equipment to be employed for each combination of the item and the process in the production plan.

In the working equipment specification support apparatus of the embodiment, the operation device may specify a priority order of the workable equipment candidate for each process based on the number of production results for each equipment of each process shown by the production result information in the processing of calculating the workable equipment candidate information and storing the workable equipment candidate information in the storage device.

According to the embodiment, it is possible to specify the equipment candidate to be used for working with high accuracy based on the number of production results. As a result, it is possible to more efficiently generate and manage the information of the working equipment to be employed for each combination of the item and the process in the production plan.

In the working equipment specification support apparatus of the embodiment, the storage device may further store information of production date and time in the production result information, and the operation device may specify a priority order of the workable equipment candidate for each process based on newness of production date and time for each equipment of each process shown by the production result information in the processing of calculating the workable equipment candidate information and storing the workable equipment candidate information in the storage device.

According to this embodiment, it is possible to specify the equipment candidate to be used for working with high accuracy based on the newness of production results. As a result, it is possible to more efficiently generate and manage the information of the working equipment to be employed for each combination of the item and the process in the production plan.

In the working equipment specification support apparatus of the embodiment, the storage device may further store equipment specification information which is a workable item attribute condition for each equipment or each combination of the equipment and the process based on equipment specifications instead of the production result, and the operation device may further execute, in a case where an equipment candidate in which the item attribute satisfies the regulations is not determined as the determination result, processing of determining whether or not a predetermined item attribute satisfies the regulations in the equipment specification information for each of the determined equipment candidates or each combination of the specified equipment candidate and the predetermined process.

According to this embodiment, even in a case where the equipment candidate to be used for working cannot be specified based on the production result, the equipment candidate can be specified based on the equipment specifications. As a result, it is possible to more efficiently generate and manage the information of the working equipment to be employed for each combination of the item and the process in the production plan.

In the working equipment specification support apparatus of the embodiment, the operation device may further execute processing of setting different status information in the storage device by an equipment candidate that is determined that the item attribute satisfies the regulations of the workable item attribute condition information and an equipment candidate that is determined that the item attribute satisfies the regulations of the equipment specification information.

According to this embodiment, for example, when the equipment candidate specification is clearly distinguished into a case in which the equipment candidate to be used for working can be specified based on the production result and a case where the equipment candidate to be used for working can be specified based on the equipment specifications, and then the distinction is presented to users, the users can take the distinction into consideration for equipment selection. As a result, it is possible to more efficiently generate and manage the information of the working equipment to be employed for each combination of the item and the process in the production plan.

What is claimed is:

1. A working equipment specification support apparatus comprising:
a storage device that stores workable equipment candidate information which is information of a workable equipment candidate for each process, and workable item attribute condition information which is a workable item attribute condition for each equipment or each combination of equipment and a process; and
an operation device that executes processing of specifying a workable equipment candidate related to a predetermined process from the workable equipment candidate information, processing of determining whether or not a predetermined item attribute satisfies regulations in the workable item attribute condition information for each specified equipment candidate or for each combination of the specified equipment candidate and the predetermined process, and processing of specifying an equipment candidate whose item attribute has been determined to satisfy the regulations in the determining processing as equipment that can perform working on an item corresponding to the item attribute in the process.

2. The working equipment specification support apparatus according to claim 1, wherein
the storage device stores information including a priority order of the workable equipment candidate for each process as the workable equipment candidate information, and
the operation device specifies the workable equipment candidate from the workable equipment candidate information based on the priority order in the processing of specifying the workable equipment candidate related to the predetermined process, and specifies the determined equipment candidate as equipment that can perform working on the item corresponding to the item attribute in the process, based on the priority order in the processing of specifying the determined equipment candidate as the equipment that can perform working on the item corresponding to the item attribute in the process.

3. The working equipment specification support apparatus according to claim 2, wherein
the storage device further stores one or more pieces of production result information including combined information of items, processes, and equipment, and item attribute information for each item, and
the operation device further executes processing of acquiring, from the storage device, item attribute information corresponding to each item that shows the production result information, processing of calculating the workable equipment candidate information based on a worked production result for each process shown by the production result information and storing the workable equipment candidate information in the storage device, and processing of calculating the workable item attribute condition information based on the production result information and the item attribute information and storing the workable item attribute condition information in the storage device.

4. The working equipment specification support apparatus according to claim 3, wherein
the operation device specifies the priority order of the workable equipment candidate for each process based on a number of production results for each equipment of each process shown by the production result information in the processing of calculating the workable equipment candidate information and storing the workable equipment candidate information in the storage device.

5. The working equipment specification support apparatus according to claim 3, wherein
the storage device stores further information of production date and time in the production result information, and
the operation device specifies the priority order of the workable equipment candidate for each process based on newness of production date and time for each equipment of each process shown by the production result information in the processing of calculating the workable equipment candidate information and storing the workable equipment candidate information in the storage device.

6. The working equipment specification support apparatus according to claim 3, wherein
the storage device further stores equipment specification information which is a workable item attribute condition for each equipment or each combination of the equipment and the process based on equipment specifications instead of the production result, and
the operation device further executes, in a case where, as a result of the determining processing, the equipment candidate whose item attribute is not determined to satisfy the regulations, processing of determining whether or not a predetermined item attribute satisfies the regulations in the equipment specification information for each determined equipment candidate or each combination of the specified equipment candidate and the predetermined process.

7. The working equipment specification support apparatus according to claim 6, wherein
the operation device further executes processing of setting different status information in the storage device by the equipment candidate whose item attribute is determined to satisfy the regulations of the workable item attribute condition information and an equipment candidate whose item attribute is determined to satisfy the equipment specification information.

8. A working equipment specification support method using an information processing system including a storage device that stores workable equipment candidate information which is information of a workable equipment candidate for each process, and workable item attribute condition information which is a workable item attribute condition for each equipment or each combination of an equipment, the information processing system being configured to:
specify the workable equipment candidate related to a predetermined process from the workable equipment candidate information;
determine whether or not a predetermined item attribute satisfies regulations in the workable item attribute condition information for each specified equipment candidate or for each combination of the specified equipment candidate and the predetermined process; and
specify an equipment candidate whose item attribute is determined to satisfy the regulations in the determination as equipment that can perform working on an item corresponding to the item attribute in the process.

9. A working equipment specification support system comprising at least:
a working equipment specification support apparatus including
a storage device that stores workable equipment candidate information which is information of a workable equipment candidate for each process, and workable item attribute condition information which is a workable item attribute condition for each equipment or each combination of equipment and a process, and
an operation device that executes processing of specifying the workable equipment candidate related to a predetermined process from the workable equipment candidate information, processing of determining whether or not a predetermined item attribute satisfies regulations in the workable item attribute condition information for each specified equipment candidate or for each combination of the specified equipment candidate and the predetermined process, and processing of specifying the equipment candidate whose item attribute is determined to satisfy the regulations in the determining processing as equipment that can perform working on an item corresponding to the item attribute in the process; and
one or more equipment that are specified as workable equipment by the working equipment specification support apparatus, generate production result information including combined information of items, processes, and equipment, and distributes the information to the working equipment specification support apparatus.
